(19) United States
(12) Patent Application Publication
(10) Pub. No.: US 2024/0430009 A1
(43) Pub. Date: Dec. 26, 2024

(54) Apparatus and Method for Simplifying the Implementation and Deployment of Optical Wavelength Division Multiplexing

(71) Applicant: Panduit Corp., Tinley Park, IL (US)

(72) Inventors: Richard J. Pimpinella, Prairieville, LA (US); Jose M. Castro, Naperville, IL (US)

(73) Assignee: Panduit Corp., Tinley Park, IL (US)

(21) Appl. No.: 18/213,458

(22) Filed: Jun. 23, 2023

(51) Int. Cl. H04B 10/40

(52) U.S. Cl. CPC H04B 10/40

(57) ABSTRACT

An apparatus having at least two user interfacing I/O data communication transceivers. The I/O transceiver utilizes either electrical or optical signaling based on user preference with each I/O transceiver being electrically connected back-to-back to a WDM transceiver in the apparatus. The optical media dependent interface of each WDM transceiver has a uniquely specified wavelength and optical ports of the WDM transceivers are connected to the corresponding wavelength ports of a WDM device. The discrete optical wavelengths are multiplexed or demultiplex onto a duplex pair of optical fibers by means of the WDM device in order to convert the interfacing I/O signals to the appropriate optical wavelengths to facilitate pre-configured WDM optical communications.

### FIELD OF INVENTION

The present invention relates generally to optical data communications employing wavelength division multiplexing (WDM). The apparatus incorporates the components required for implementing WDM technology and is compatible with standard structured cabling. The apparatus and method thereof convert input and output data streams into discrete specified WDM wavelengths, and couple said specified wavelengths into a single strand of SMF, thereby simplifying the deployment of WDM technology. The apparatus and method enable the transmission of multiple data streams over single-mode fiber (SMF), increasing the bandwidth of the Structured cabling.

### BACKGROUND

Wavelength division multiplexing has long been the technology of choice for transporting large amounts of data between sites, FIG. 1. It increases bandwidth by allowing different data streams to be sent simultaneously over a signal strand of optical fiber. In this way, WDM maximized the usefulness of fiber and optimizes network investments. Traditionally WDM systems have been adopted by carriers and service providers, employing large-scale systems designed for “national infrastructures” making the systems prohibitively expensive and too complex for private network use. In recent years, however, things have changed, and the technology is evolving rapidly reducing system cost. Today lower cost WDM devices and wavelength-specific optical transmitters are available that meet the needs of corporate enterprises, governmental organizations, and privately owned data centers. Solutions that are simpler and more cost-effective than the traditional carrier-grade ones.

The foundation of WDM lies in the ability to send different data types over fiber networks in the form of light. By allowing different light channels, each with a unique wavelength, to be sent simultaneously over an optical fiber, instead of using multiple fibers for each and every service, a single fiber can be shared for several services. In this way, WDM increases the bandwidth and maximizes the usefulness of fiber. Fiber rental or purchase represents a significant share of networking costs. So using an existing fiber to transport multiple traffic channels can generate substantial savings.

FIG. 1 shows an exemplary 8-channel WDM system 100, where transceivers 101 through 108 are located in Enterprise 130, and where each optical transceiver is selected to have a uniquely specified wavelength, λ1 through λ8, respectively. For simplicity, only one direction of the duplex channel is shown. The output of transceivers 101 to 108 are launched in the WDM 121, where the signals are combined (multiplexed) and transmitted over single-mode optical fiber (SMF) 120. A second WDM 122 must be present at destination 131, to receive and demultiplex the optical channels 101 to 108. In this scenario, demux 122 separates optical wavelengths 21 through 18 and directs the discrete wavelengths to transceivers 111 through 118 respectively, completing the optical channels. Typically, optical transmission utilizes a duplex pair of fibers for both transmit and receiver signaling and therefore, system 100 must provide multiplexing for both transmit and receive channels.

For WDM system compatibility, unique wavelengths are specified in ITU-T Standards, where up to 80 channels can be simultaneously transmitted through a fiber at any one time. Users have the option of selecting a wavelength grid, having pre-defined wavelengths with the necessary wavelength guardbands.

In FIG. 2, we show the optical communications spectrum which has evolved over the past 40 years. The original wavelengths used for long-haul optical communications in the early 1980s were in the 1310 nm window (O-band), however, the attenuation in glass optical fiber reduces as the wavelength increases. To achieve longer communication distances (reach), optical communication wavelengths were shifted to longer wavelengths in the 1550 nm window, referred to as the “Conventional” band or C-Band. Today, we have 6 specific wavelength bands to support the variety of WDM system designs.

For lowest cost optical communications, the IEEE 802.3 Ethernet Standards body has selected WDM grids that utilize the broadest spectral widths and guardbands between wavelengths to increase wavelength tolerances in the manufacture of laser transmitters, thereby reducing cost. In FIG. 3, we show the spectral wavelength grids currently specified for Ethernet communications, where the colored lines indicate wavelength and guardband ranges.

For long-distance communications, the chromatic dispersion of the optical signals must be kept to a minimum and therefore, for Long-reach “L” designated physical media devices (PMDs), such as 400GBASE-LR8 301, a tighter WDM grid was chosen. These long-reach transceivers require tight control of the center wavelength, spectral widths, and guardbands, increasing channel cost. For shorter reach, it is more cost-effective to select Course-WDM (CWDM) grid 302, having a 20 nm center wavelength window and a 10 nm guardband as opposed to Long-haul WDM PMDs with only 2 nm wavelength windows and guardbands.

Hence, for short-reach applications such as Enterprise optical network communications, it is advantageous to utilize the CWDM grid as illustrated in FIG. 4. The CWDM wavelength grid is listed in the table of FIG. 4, specifying 18 wavelengths distributed over 5 spectral bands.

The difficulty of deploying a WDM system begins with the acquisition of wavelength-specific transceivers and compatible WDM devices, then managing the WDM port assignments, and lastly, the pairing of channel wavelengths. Long-term maintenance of the channels can also pose significant challenges if the transceivers are no longer available. Hence, there is a need for a device that simplifies the deployment of WDM systems.

### SUMMARY

An apparatus having at least two user interfacing I/O data communication transceivers. The I/O transceiver utilizes either electrical or optical signaling based on user preference with each I/O transceiver being electrically connected back-to-back to a WDM transceiver in the apparatus. The optical media dependent interface of each WDM transceiver has a uniquely specified wavelength and optical ports of the WDM transceivers are connected to the corresponding wavelength ports of a WDM device. The discrete optical wavelengths are multiplexed or demultiplex onto a duplex pair of optical fibers by means of the WDM device in order to convert the interfacing I/O signals to the appropriate optical wavelengths to facilitate pre-configured WDM optical communications.

### BRIEF DESCRIPTION OF THE DRAWINGS

FIG. 1 shows an exemplary 8-channel WDM system.

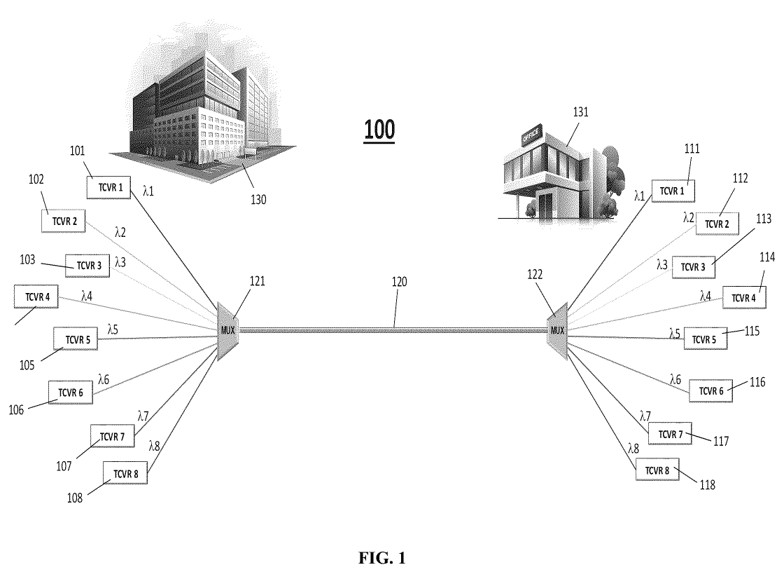

FIG. 2 shows how the optical communications spectrum has evolved over the past 40 years.

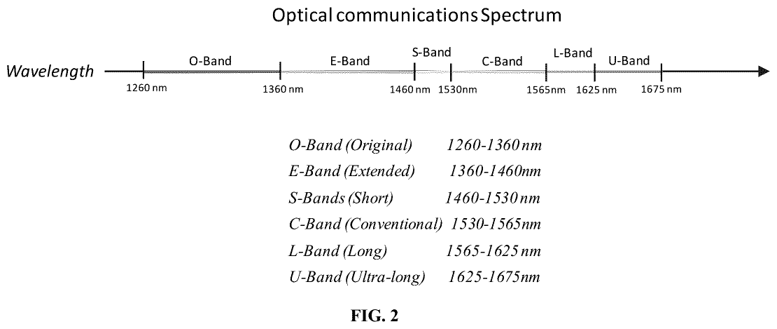

FIG. 3 shows spectral wavelength grids currently specified for Ethernet communications.

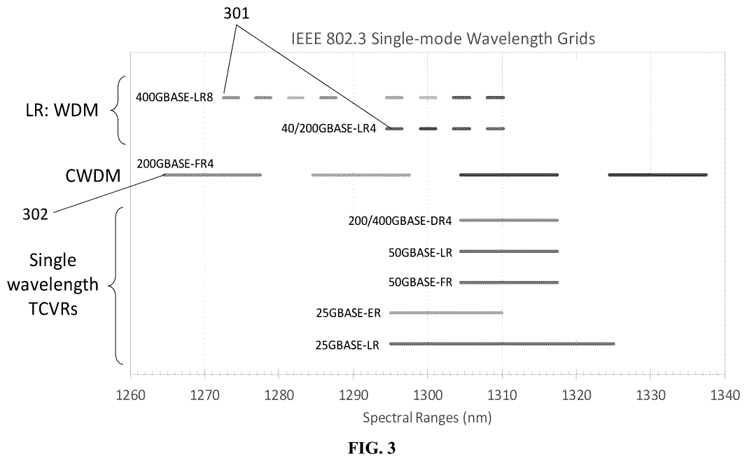

FIG. 4 shows the CWDM wavelength grid, specifying 18 wavelengths distributed over 5 spectral bands.

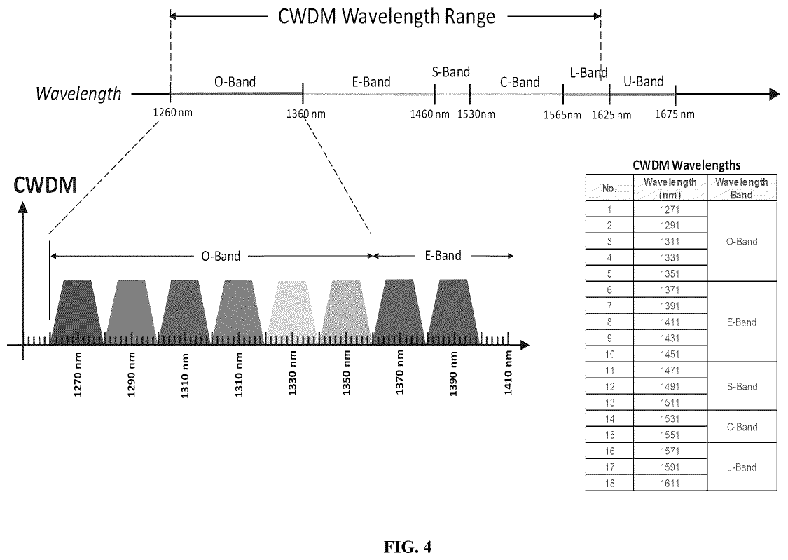

FIG. 5 shows an embodiment of the present invention.

FIG. 6 illustrates the interconnection between two 8-channel WDM systems in accordance with the present invention.

FIG. 7 illustrates one exemplary application of the disclosed apparatus 500.

### DESCRIPTION OF INVENTION

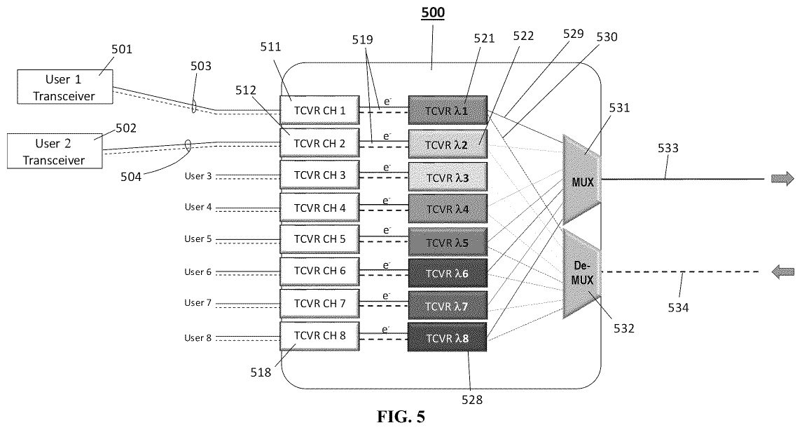

The disclosed apparatus and method thereof simplifies the deployment of WDM systems by providing the end user with pre-packaged wavelength-specified transceivers and WDM devices needed to implement a WDM system (plug and play). It is advantageous for channel transceivers 511 through 518 (513-517 not labeled) in apparatus 500 (FIG. 5), to have Standards specified pluggable form factors such as small form factor pluggable (SFP) or Quad-SFP (QSFP) packaged transceivers. In this way, users have the option of communicating with apparatus 500 via optical or electrical signaling depending on their choice of transceivers 1 (501) and 2 (502). Users can also deploy any combination of optical or electrical transceivers to interface with apparatus 500.

In accordance with the present invention, channel transceivers 511 through 518 convert the incoming optical or electrical data streams, in this example, 503 and 504, to electrical signaling 519, which in turn drives the internal WDM transceivers 521 and 522 (523-527 not labeled), which provide the specified pre-defined WDM wavelengths λ1 and λ2 to internal multiplexer 531. The channel return path is implemented via de-multiplexer 532. Hence, the need for end users to select, acquire, and manage wavelength-specific optical transceivers is eliminated.

Although apparatus 500 is shown as having 8 WDM channels, the apparatus can include up to 80 Dense-WDM (DWDM) wavelength channels or as few as 2 CDWM channels depending on user requirements. To simplify the installation process, it is advantageous for apparatus 500 to be designed for compatibility with Structured Cabling.

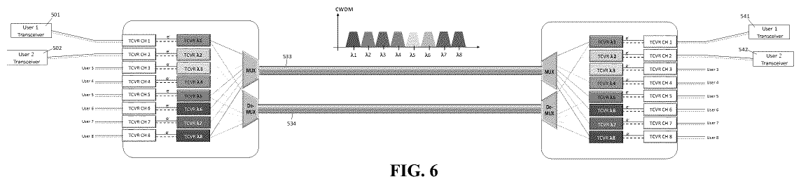

In FIG. 6, we illustrate the interconnection between two 8-channel WDM systems in accordance with the present invention, interconnecting 16 users over 8 WDM wavelengths. The 8 independent channels share a single duplex pair of single-mode optical fibers 533 and 534.

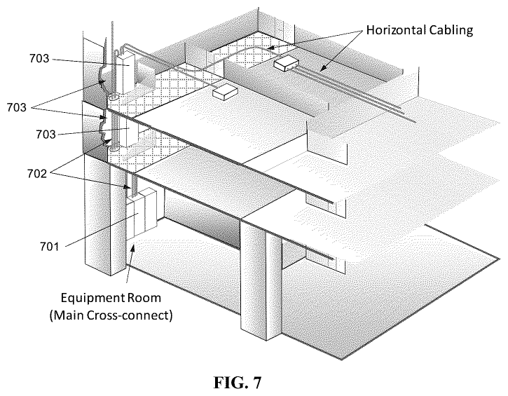

FIG. 7, illustrates one exemplary application of the disclosed apparatus 500. In this scenario, we assume the bandwidth of an existing optical riser cabling 702 in an Enterprise network is limited and consequently, would typically require the installation of additional cabling. However, by utilizing apparatus 500, in the equipment room cabinet 701, the existing cabling can be repurposed for multiple WDM channels to support multiple services and users. Services on multiple floors can also be supported using WDM add/drop modules located at access points along the cable path, for example, in cabinet 703. The use of wavelength compatible add/drop modules can re-direct one or more of the channel wavelengths by demultiplexed and multiplexing pre-defined wavelengths carrying a specified wavelength.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An apparatus comprising at least two user interfacing I/O data communication transceivers, the interfacing I/O data communication transceivers utilizing either electrical or optical signaling based on user preference and wherein each interfacing I/O data communication transceiver is electrically connected back-to-back to a WDM transceiver in the apparatus, an optical media dependent interface of each WDM transceiver has a uniquely specified wavelength, and optical ports of the WDM transceivers are connected to corresponding wavelength ports of a WDM device, and discrete optical wavelengths are multiplexed or demultiplex onto a duplex pair of optical fibers by means of said WDM device in order to convert the interfacing I/O signals to appropriate optical wavelengths to facilitate pre-configured WDM optical communications.

2. The apparatus of claim 1, wherein the at least two interfacing input/output transceivers are optical Physical Media Dependent transceivers compliant with IEEE 802.3 Standards.

3. The apparatus of claim 1, wherein the at least two interfacing input/output transceivers are optical Physical Media Dependent transceivers compliant with Fibre Channel Physical Layer Standards.

4. The apparatus of claim 1, wherein the at least two interfacing input/output transceivers are electrical Physical Media Dependent (PMD) transceivers compliant with IEEE 802.3 Standards.

5. The apparatus of claim 1 wherein the apparatus is configured for plug-and-play compatibility with structured cabling.
